(19) United States
(12) Patent Application Publication
(10) Pub. No.: US 2024/0331203 A1
(43) Pub. Date: Oct. 3, 2024

(54) COMPUTER SYSTEM AND DATA COMPRESSING METHOD

(71) Applicant: Hitachi, Ltd., Tokyo (JP)

(72) Inventors: Takahiro NARUKO, Tokyo (JP); Hiroaki AKUTSU, Tokyo (JP)

(21) Appl. No.: 18/583,030

(22) Filed: Feb. 21, 2024

(30) Foreign Application Priority Data
Mar. 31, 2023 (JP) 2023-058140

(51) Int. Cl. G06T 9/00; G06T 3/40

(52) U.S. Cl. CPC G06T 9/00; G06T 3/40

(57) ABSTRACT

To efficiently generate compressed data having ensured compatibility with a transmission destination. A computer system includes: a model configured to output inference data indicating importance of each region of multi-dimensional data; a compression level information generation unit configured to generate compression level information including a parameter for determining a data amount for each region of the multi-dimensional data based on the inference data; and a compressor configured to generate the compressed data in a data format having ensured compatibility with a transmission destination of compressed data by lossy compression using the compression level information.

### CLAIM OF PRIORITY

The present application claims priority from Japanese patent application JP 2023-058140 filed on Mar. 31, 2023, the content of which is hereby incorporated by reference into this application.

### BACKGROUND OF THE INVENTION

### 1. Field of the Invention

The present invention relates to a compression technique for reducing a volume of data.

### 2. Description of Related Art

From the viewpoint of cost reduction required for accumulation and transfer of data, a lossy compression technique with a high compression ratio is required. Further, in addition to the high compression ratio, the lossy compression technique is also required to have high efficiency from the viewpoint of reducing a calculation cost required for compression. From the viewpoint of compatibility, it is desirable that the compressed data generated by the lossy compression technique conforms to a data format which is generally widely used.

As an example of the lossy compression technique, Advanced Video Coding (AVC), High Efficiency Video Coding (HEVC), Versatile Video Coding (VVC), and the like, which are standardized compression techniques in video data, are known.

In addition, a technique is known in which a Deep Neural Network (DNN) such as an auto encoder is used to generate compressed data by controlling a bit allocation amount for each region of multi-dimensional data based on importance for each region (paragraphs 0169 to 0178 of PTL 1).

In industrial data, there is a case where it is not necessary to reproduce all information included in the data with high fidelity after compression and decompression. For example, when a power transmission steel tower is inspected using video data captured by a drone, high image quality is required in a region where the power transmission steel tower is imaged, whereas image quality deterioration is allowable in a region of a background plant or the like. According to PTL 1, a region where an important object such as a power transmission steel tower exists is made to have high image quality, and a bit allocation amount is controlled so as to highly compress the other region, so that it is possible to generate data that is suitable for an application and has a high compression ratio.

### CITATION LIST

### Patent Literature

PTL1: JP2020-155071A

### SUMMARY OF THE INVENTION

In the technique disclosed in PTL 1, a high compression ratio can be expected. However, since what bit string is generated by the DNN as compressed data is determined by learning, there is a problem (problem 1) that the compressed data generated by the lossy compression technique disclosed in PTL 1 has no compatibility with a generally used data format such as AVC.

A representative example of the invention disclosed in the present application is as follows. That is, a computer system includes: at least one computer including a processor, a storage device connected to the processor, and an interface connected to the processor; a model configured to output inference data indicating importance of each region of multi-dimensional data; a compression level information generation unit configured to generate compression level information including a parameter for determining a data amount for each region of the multi-dimensional data based on the inference data; and a compressor configured to generate the compressed data in a data format having ensured compatibility with a transmission destination of compressed data by lossy compression using the compression level information.

According to the invention, the compressed data having ensured compatibility with a transmission destination can be efficiently generated. The problems, configurations, and effects other than those described above will become apparent in the following description of embodiments.

### BRIEF DESCRIPTION OF THE DRAWINGS

FIG. 1 is a diagram showing an outline of a system according to a first embodiment;

FIG. 2 is a diagram showing an example of a configuration of the system according to the first embodiment;

FIG. 3 is a diagram showing an example of a data structure of preprocess parameter management information according to the first embodiment;

FIG. 4 is a diagram showing an example of a data structure of important object designation information according to the first embodiment;

FIG. 5 is a flowchart showing an example of a registration process of important object designation data executed by a compression unit according to the first embodiment;

FIG. 6 is a diagram showing an example of an important object designation interface provided by the compression unit according to the first embodiment;

FIG. 7 is a flowchart showing an example of a compression process executed by the compression unit according to the first embodiment;

FIG. 8 is a flowchart showing an example of a preprocess executed by the compression unit according to the first embodiment;

FIG. 9 is a flowchart showing an example of a compression level information generation process executed by the compression unit according to the first embodiment;

FIG. 10 is a diagram showing an example of a data structure of the important object designation information according to a second embodiment;

FIG. 11 is a diagram showing an example of the important object designation interface provided by the compression unit according to the second embodiment;

FIG. 12A is a diagram showing another example of the data structure of important object designation information according to the second embodiment;

FIG. 12B is a diagram showing another example of the data structure of important object designation information according to the second embodiment;

FIG. 13A is a diagram showing another example of the important object designation interface provided by the compression unit according to the second embodiment; and

FIG. 13B is a diagram showing another example of the important object designation interface provided by the compression unit according to the second embodiment.

### DESCRIPTION OF EMBODIMENTS

The technique described in PTL 1 has the following problems in addition to the above-described problem. (Problem 2) Since a definition of an important object and a bit allocation amount for each region are hard coded as learning parameters of DNN, when the definition of the important object is changed, a large number of pieces of training data including supervised data indicating the important object is required, and it takes time for relearning. (Problem 3) The DNN receives an input of original data having high resolution, and executes determination of the bit allocation amount and the generation of the compressed data, and thus, a compression speed is slow. For example, when a convolutional neural network is used as a DNN, an amount of calculation generally increases in proportion to the input resolution. Therefore, it takes a lot of time to process data with high resolution such as Full HD and 4K.

Hereinafter, embodiments of the invention for solving the three problems will be described with reference to the drawings. However, the invention is not to be construed as being limited to the contents described in the following embodiments. It will be easily understood by those skilled in the art that the specific configuration can be changed without departing from the spirit or scope of the invention.

In the configurations of the invention described below, the same or similar configurations or functions are denoted by the same reference signs, and redundant description will be omitted.

### First Embodiment

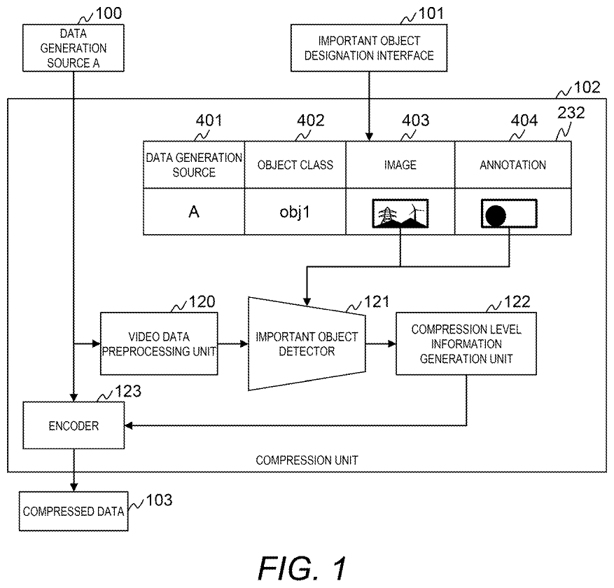

First, an outline of a system according to a first embodiment will be described with reference to FIG. 1. FIG. 1 is a diagram showing the outline of the system according to the first embodiment.

The system according to the first embodiment includes a data generation source 100, an important object designation interface 101, and a compression unit 102.

The data generation source 100 is a subject that generates data to be compressed, and is, for example, an image sensor that generates video data. In the embodiment, a case where the data generation source 100 is the image sensor that generates video data will be described as an example.

The data generation source 100 and the generated data are not limited thereto, and may be an image sensor that generates still image data, a vibration sensor that generates one-dimensional time-series data, or the like. The data generation source 100 is not limited to a sensor, and may be software such as Computer Graphics that generates video data and still image data. In addition, the data of the data generation source 100 may be, for example, data obtained by processing data generated by a sensor, software, or the like, such as a Segmentation Map obtained by applying a machine learning model of Semantic Segmentation to each frame of video data. The data of the data generation source 100 may be a video file or the like stored in a recording device. A plurality of data generation sources 100 may be provided.

The compression unit 102 is a module that compresses the data generated by the data generation source 100. The compression unit 102 may generate compressed data 103 for each frame of a video or may generate the compressed data 103 for each of a predetermined number of frames. The compression unit 102 includes a video data preprocessing unit 120, an important object detector 121, a compression level information generation unit 122, and an encoder 123.

When the video data to be compressed is acquired, the compression unit 102 inputs a frame of the data (hereinafter, referred to as an original frame) to the video data preprocessing unit 120. The video data preprocessing unit 120 executes a preprocess such as downscaling on the input original frame to generate a processed frame in which resolution or the like is changed.

The important object detector 121 receives important object designation data stored in important object designation information 232 (see FIG. 4) and the processed frame generated by the video data preprocessing unit 120, and calculates, for each pixel in the processed frame, a probability that the pixel is the important object.

The important object detector 121 is, for example, the machine learning model of Semantic Segmentation using a technique of Few-shot learning or Zero-shot learning.

The compression level information generation unit 122 calculates compression level information for each compression unit of the encoder 123 based on a processing result of the important object detector 121.

The encoder 123 compresses the original frame based on the compression level information generated by the compression level information generation unit 122 to generate the compressed data 103. The encoder 123 is, for example, an encoder of a standardized video codec such as AVC. The encoder 123 is not limited to the software encoder described above, and may be an HEVC encoder or a hardware encoder.

Here, the compression level information is a parameter of the encoder 123 that controls a bit allocation amount for each region. When the encoder 123 is an encoder conforming to AVC, the compression unit of the encoder 123 is a macro block, and the compression level information is a value (QP value) of a Quantization Parameter for each macro block, difference information of the QP value for each macro block, information designating an enhancement degree of image quality for each macro block, or the like. In this case, for example, the compression level information generation unit 122 calculates a maximum value of the probability for each macro block with respect to an output of the important object detector 121, assigns a predetermined QP value to a macro block having the maximum value larger than a predetermined threshold, and generates, as the compression level information, spatial distribution information of the QP value in which the predetermined QP value having a relatively large value is assigned to the other macro blocks. The compression level information described above is an example, and the invention is not limited thereto.

The important object designation information 232 is information for managing pairs of images and annotation data that include an important object for each combination of the data generation source 100 and a class of the important object. The important object designation information 232 shown in FIG. 1 stores the important object designation data in which a power transmission steel tower is designated as an important object of a data generation source A. In the important object designation data, an image in which the power transmission steel tower is captured and annotation data representing a region in the image where the power transmission steel tower is present are associated with an identifier of the data generation source A and an identifier indicating a class of the power transmission steel tower designated by the user. A plurality of important objects may be designated for one data generation source 100, or a plurality of pieces of important object designation data defining one important object may be registered. The important object designation data is set by the user via the important object designation interface 101.

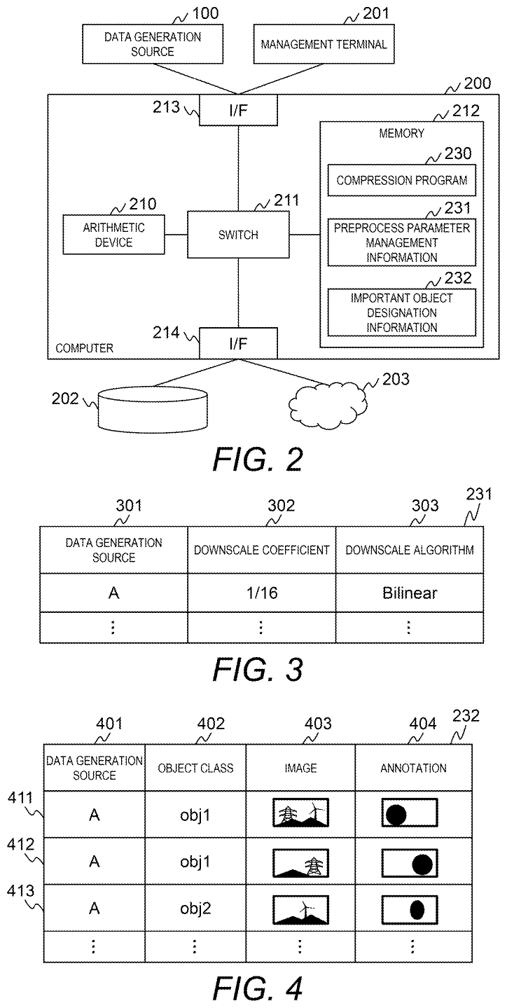

A configuration of the system according to the first embodiment will be described with reference to FIG. 2. FIG. 2 is a diagram showing an example of the configuration of the system according to the first embodiment.

A computer 200 is hardware that implements the compression unit 102, and includes, for example, an arithmetic device 210, a switch 211, a memory 212, a front-end interface 213, and a back-end interface 214.

The front-end interface 213 is an interface for connecting to the data generation source 100 and a management terminal 201. The back-end interface 214 is an interface for connecting to a storage device 202 and a network 203.

The arithmetic device 210 is a device that controls the entire computer 200, and is a general-purpose arithmetic device such as a central processing unit (CPU), an accelerator such as a graphical processing unit (GPU) and a field programmable gate array (FPGA), or a hardware encoder/decoder of a standard codec such as HEVC, or a combination of the above-described components. The arithmetic device 210 is connected to the memory 212 and the like via the switch 211.

The memory 212 stores a program to be executed by the arithmetic device 210 and information used by the program. The memory 212 is also used as a work area. The memory 212 according to the first embodiment stores a compression program 230 for implementing the compression unit 102, the preprocess parameter management information 231, and the important object designation information 232. The memory 212 may store programs such as an operating system (OS) and information.

The storage device 202 may be a block device including a hard disk drive (HDD) and a solid-state drive (SSD), may be a file storage, may be a content storage, may be a volume constructed on a storage system, or may be implemented by any method of accumulating data. When there is no need to store the compressed data, the storage device 202 may be omitted.

The network 203 is a communication network such as a local area network (LAN) and the Internet. The compression unit 102 can transmit the compressed data 103 to another device via the network 106. When it is not necessary to transmit the compressed data 103 to another device, the network 203 may be omitted.

The compression unit 102 may be implemented by using hardware in which pieces of hardware such as an integrated circuit (IC) are connected to each other, and some of the functions of the compression unit 102 may be implemented by using one semi-conductor element as an application specific integrated circuit (ASIC) and an FPGA. The compression unit 102 may be implemented by using a virtual machine (VM) implemented by a virtualization technique. Further, components other than those shown here may be added.

The data generation source 100, the management terminal 201, the computer 200, and the storage device 202 may be different hardware devices, may be VMs operating on a same computer, may be different containers operating on a same operating system (OS), or may be applications operating on a same OS. Further, a plurality of mounting forms may be combined. For example, the data generation source 100 is an image sensor, the compression unit 102 is an edge device connected to the image sensor and including the arithmetic device 210, the management terminal 201 is a terminal operable by a user, and the storage device 202 is an HDD.

FIG. 3 is a diagram showing an example of a data structure of the preprocess parameter management information 231 according to the first embodiment.

The preprocess parameter management information 231 is, for example, data in a table format, and stores an entry including a data generation source 301, a downscale coefficient 302, and a downscale algorithm 303. The field included in the entry is an example, and the entry is not limited to this example.

The data generation source 301 is a field for storing the identifier of the data generation source 100. The identifier of the data generation source 100 is, for example, a character string named by a user, a Media Access Control (MAC) address or an Internet Protocol (IP) address assigned to the data generation source 100, or any code with which the data generation source 100 can be identified. When the data generation source 100 is obvious, the entry may not include the data generation source 301.

The downscale coefficient 302 and the downscale algorithm 303 are fields for storing parameters for controlling the conversion of the original frame.

In the preprocess parameter management information 231 shown in FIG. 3, an entry for defining a preprocess for reducing vertical and horizontal lengths of the original frame of the data generation source A to 1/16 by using a Bilinear algorithm is set.

The preprocess parameter management information 231 may be set by the user via the management terminal 201, may be automatically set by the arithmetic device 210 at the time of starting the compression unit 102 or adding the new data generation source 100, or may be set by another method. For example, when the data generation source 100 is added, the arithmetic device 210 can check the codec of the encoder 123 and determine a downscale coefficient based on a check result. For example, when the codec of the encoder 123 is AVC and the compression level information can be designated by the QP value in units of macro blocks of 16 pixels×16 pixels, the arithmetic device 210 can set 1/16 as the downscale coefficient 302 based on the information that the encoder 123 is the AVC encoder.

Note that, although a processing time increases as the downscale coefficient increases, a tread-off that improves accuracy of the important object detector 121 exists, and thus, a value different from a reciprocal of a length of a piece of the macro block may be set as the downscale coefficient. The downscale coefficient is not necessarily a constant and may be dynamically changed for each frame. For example, the downscale coefficient may be dynamically adjusted until the downscale coefficient reaches the minimum reciprocal of the length of a piece of the macro block by a method in which, first, processing is performed with the downscale coefficient of 1 (that is, the resolution is not changed), and if an area of the important object detected by the important object detector 121 is large, it is determined that the important object is imaged in a relatively large size and there is no large influence on the detection even if downscaling is performed, and the downscale coefficient is reduced to ½ in the next frame. The adjustment process may be implemented again at predetermined frame intervals. Further, a range of values to be dynamically adjusted may be managed by the preprocess parameter management information 231.

The method of setting the various fields of the preprocess parameter management information 231 is not limited thereto.

The preprocess parameter management information 231 may have a data structure capable of managing parameters related to the frame conversion, and may have a data structure other than a table, such as an Extensible Markup Language (XML), a YAML Ain't Markup Language (YAML), a hash table, and a tree structure.

FIG. 4 is a diagram showing an example of a data structure of the important object designation information 232 according to the first embodiment.

The important object designation information 232 is, for example, data in a table format, and stores an entry including a data generation source 401, an object class 402, an image 403, and an annotation 404. The field included in the entry is an example, and the entry is not limited to this example.

The data generation source 401 is a field for storing the identifier of the data generation source 100, and is the same as the data generation source 301.

The object class 402 is a field for storing an identifier representing a class of an important object. The identifier is, for example, a character string named by a user, but is not limited thereto. When one piece of important object designation data is set for one class of important object, the entry may not include the object class 402.

The image 403 and the annotation 404 are fields for storing an image and annotation data for designating an important object. For example, an image including an important object is stored in the image 403, and a monochrome image (annotation data) indicating a region in the image where the important object exists is stored in the annotation 404. The annotation data is not limited to that described above. For example, the annotation data may be XML data in which coordinates and a size of a Bounding Box representing the region where the important object exists are stored, or data in any other data format.

Here, a specific example of information stored in the important object designation information 232 will be described with reference to FIG. 4. The important object designation information 232 shown FIG. 4 stores important object in designation data related to two classes of the important object “ob1” and “ob2” for the data generation source 100 to which an identifier “A” is assigned. The important object to which the identifier “ob1” is assigned is a power transmission steel tower, and two pieces of important object designation data 411 and 412 are set. The image 403 of the important object designation data 411 and 412 stores an image including the power transmission steel tower, and the annotation 404 stores a monochrome image representing the region in the image where the power transmission steel tower exists. The important object to which the identifier “ob2” is assigned is a wind power generator, and one piece of important object designation data 413 is set. The image 403 of the important object designation data 413 stores an image including the wind power generator, and the annotation 404 stores a monochrome image representing a region in the image where the wind power generator exists.

The data structure of the important object designation information 232 is not limited to the data in the table format, and may be a data structure other than a table, such as XML, YAML, a hash table, and a tree structure.

The important object designation information 232 may be divided into information for managing the association between the data generation source and the object class, and information for managing the association among the object class, the image, and the annotation data. By managing in this manner, definition information of an important object can be shared by a plurality of data generation sources 100.

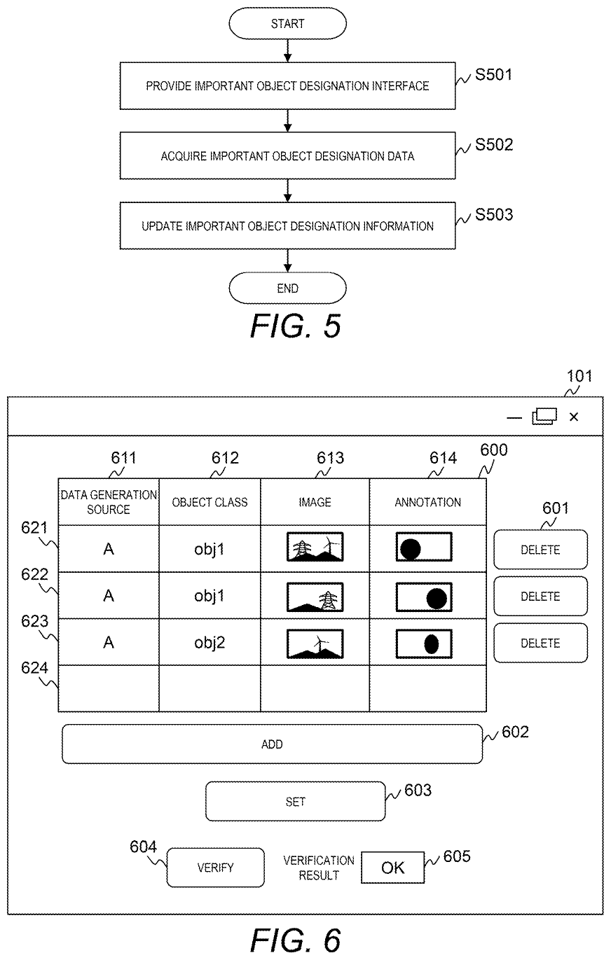

Next, a process executed by the compression unit 102 will be described with reference to FIGS. 5 to 9.

FIG. 5 is a flowchart showing an example of a registration process of important object designation data executed by the compression unit 102 according to the first embodiment. FIG. 6 is a diagram showing an example of the important object designation interface 101 provided by the compression unit 102 according to the first embodiment.

When the arithmetic device 210 functioning as the compression unit 102 receives a request from the management terminal 201 via the front-end interface 213, the arithmetic device 210 starts the process described below. An execution timing of the process is not limited to that described above, and may be activation of the computer 200 or the like.

The arithmetic device 210 provides the important object designation interface 101 for setting the important object designation data to the management terminal 201 via the front-end interface 213 (step S501). Here, the important object designation interface 101 will be described with reference to FIG. 6.

The important object designation interface 101 is displayed on a display device (not shown) of the management terminal 201. The user operates the important object designation interface 101 using an input device (not shown) of the management terminal 201.

A table 600 is displayed on the important object designation interface 101. The table 600 is a table for checking and registering an entry (important object designation data) including a data generation source 611, an object class 612, an image 613, and an annotation 614. The data generation source 611, the object class 612, the image 613, and the annotation 614 are the same fields as the data generation source 401, the object class 402, the image 403, and the annotation 404.

The table 600 may display the important object designation data registered in the important object designation information 232. Entries 621, 622, and 623 in FIG. 6 are the important object designation data registered in the important object designation information 232.

A delete button 601 is an operation button for deleting an entry from the table 600. When the user operates the delete button 601, the important object designation data corresponding to the entry is deleted from the important object designation information 232. The important object designation data may be deleted by an operation other than the operation of the delete button 601.

An add button 602 is an operation button for adding an entry to the table 600. After a value is set in a last entry, an entry may be automatically added. In this case, the add button 602 is unnecessary.

An entry 624 is an entry added by operating the add button 602. The identifier of the important object may be directly input by the user or can be selected by the user by displaying a drop-down list. The drop-down list includes identifiers of existing object classes and “new”. When “new” is selected, the arithmetic device 210 automatically generates and assigns an identifier. The user may input a direct file path, or the user may operate an operation button such as a Brows button displayed in a field, thereby selecting an image. The user may directly input the annotation data generated in advance, or the user may operate an operation button such as a Brows button displayed in a field, thereby selecting the annotation data. When the annotation 614 is clicked, the management terminal 201 may display a depicting screen of the annotation data, and on the screen, the user is allowed to depict the annotation data representing the region where the important object exists.

A setting button 603 is an operation button for registering contents of the table 600 in the important object designation information 232. When the user operates the setting button 603, the management terminal 201 transmits a registration request including the table 600 to the compression unit 102. The compression unit 102 receives the registration request via the front-end interface 213 and updates the important object designation information 232 according to the contents of the table 600.

A verification button 604 is an operation button for verifying the contents of the table 600. When the user operates the verification button 604, the management terminal 201 transmits a verification request of the table 600 to the compression unit 102. The compression unit 102 receives the verification request via the front-end interface 213, verifies the contents of the table 600, and responds with a result to the management terminal 201. The management terminal 201 displays the result in a field 605. For example, the compression unit 102 infers the image 613 with the important object detector 121, evaluates an error of the result with respect to the annotation 614, verifies whether the contents of the table 600 are sufficient, and can respond with a result with a binary value of OK or NG. The specific content of the verification process is not limited thereto. The verification process may be executed by the management terminal 201. The verification result is not limited to the binary value of OK or NG, and an image obtained by visualizing the result of inference of the image 613 with the important object detector 121 may be displayed in the field 605, or any other information may be displayed.

The important object designation interface 101 is described above. The important object designation interface 101 is not limited to that shown in FIG. 6. Other information (not shown) may be displayed, different operation methods may be used, or different designs may be used. Returns to the description of FIG. 5.

The arithmetic device 210 acquires the important object designation data received via the important object designation interface 101 (step S502), and updates the important object designation information 232 based on the data (step S503). Thereafter, the arithmetic device 210 ends the registration process of the important object designation data.

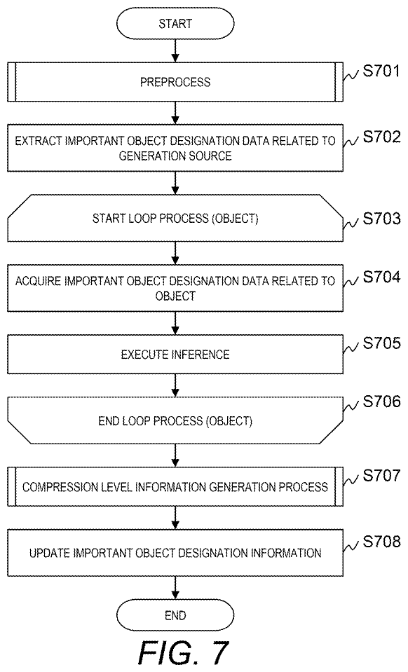

FIG. 7 is a flowchart showing an example of a compression process executed by the compression unit 102 according to the first embodiment.

For example, when the arithmetic device 210 functioning as the compression unit 102 receives a new original frame via the front-end interface 213, the arithmetic device 210 starts the compression process described below.

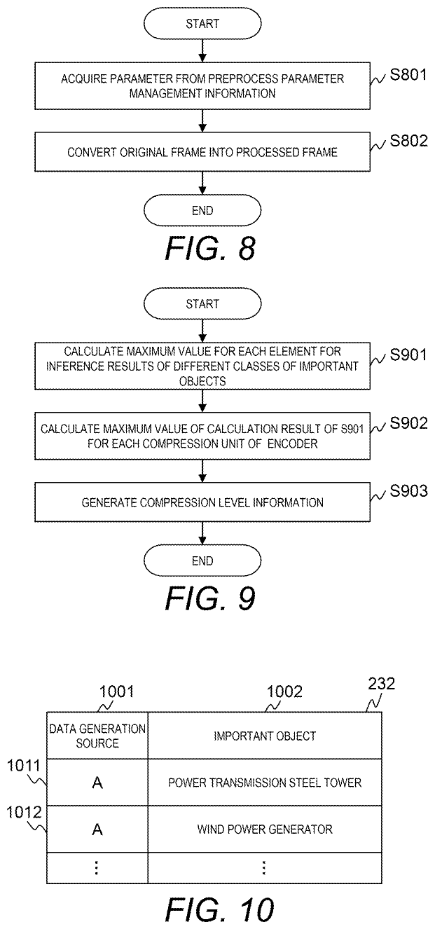

The arithmetic device 210 executes a preprocess on the acquired original frame (step S701). Details of the preprocess will be described with reference to FIG. 8. In the preprocess, a processed frame is generated by executing the preprocess such as downscaling.

The arithmetic device 210 extracts the important object designation data related to the data generation source 100 of the original frame from the important object designation information 232 (step S702).

For example, when the important object designation information 232 has the data structure shown in FIG. 4, the arithmetic device 210 extracts an entry (important object designation data) in which the identifier of the data generation source 100 of the original frame is stored in the data generation source 401. When the identifier of the data generation source 100 is “A”, the entries 411, 412, and 413 are extracted.

The arithmetic device 210 starts a loop process of the important object (step S703). Specifically, the arithmetic device 210 specifies the classes of the important objects based on the important object designation data extracted in step S702, and selects one class of object from the specified classes of the important objects. For example, when the entries 411, 412, and 413 are extracted in step S702, the arithmetic device 210 selects one class from “ob1” and “ob2”. In this case, two loop processes are executed.

The arithmetic device 210 acquires an image and annotation data from the important object designation data related to the selected class of the important object (step S704). In the case of the loop process of “ob1”, the arithmetic device 210 acquires an image and annotation data from each of the entries 411 and 412.

The arithmetic device 210 sets a combination of the acquired image and annotation data as a support set, and executes inference of the important object detector 121 using the processed frame as a query (step S705).

When the important object detector 121 is a deep learning model of Semantic Segmentation using the technique of Few-shot learning, the important object detector 121 outputs a two-dimensional tensor representing the probability that an important object designated by the support set exists for each region of a query image with the query image and the support set as inputs. The support set includes one or more combinations of images and annotation data. When the number of combinations of images and annotation data included in the support set is large, detection accuracy is high.

The important object detector 121 is not limited thereto, and may be, for example, a deep learning model of Object detection using the technique of Few-shot learning.

In addition, a relearning process such as Fine-tuning may be performed on the whole or a part of the important object detector 121 or a process added to the important object detector 121. For example, in a step immediately before the inference processing (step S705) or in the registration process of the important object designation data, the parameters of the important object detector 121 can be relearned using the support set as the supervised data. Note that, by relearning the deep learning model of Semantic Segmentation using the technique of Few-shot learning, the relearning process and the designation according to the support set may be combined. In addition, the relearned parameters may be managed as the important object designation data.

In step S706, it is determined whether the process is completed for all the specified classes of the important object. When the process is not completed for all the specified classes of the important object, the arithmetic device 210 returns to step S703 and executes the same process.

When the process is completed for all the specified classes of the important object, the arithmetic device 210 executes a compression level information generation process using inference results of different classes of the important object (step S707). Details of the compression level information generation process will be described with reference to FIG. 9.

The arithmetic device 210 generates the compressed data based on the original frame and the compression level information (step S708). Thereafter, the arithmetic device 210 transmits the compressed data to the storage device 202 or a device connected via the network 203 via the back-end interface 214, and ends the process.

FIG. 8 is a flowchart showing an example of the preprocess executed by the compression unit 102 according to the first embodiment.

The arithmetic device 210 acquires the parameters stored in the entry corresponding to the data generation source 100 of the received original frame from the preprocess parameter management information 231 (step S801).

The arithmetic device 210 converts the original frame into the processed frame based on the acquired parameters (step S802), and ends the preprocess.

For example, in the case of the preprocess parameter management information 231 shown in FIG. 4, the vertical and horizontal lengths of the frame received from the data generation source A are reduced to 1/16 based on the Bilinear algorithm.

FIG. 9 is a flowchart showing an example of the compression level information generation process executed by the compression unit 102 according to the first embodiment.

The arithmetic device 210 calculates a maximum value for each element for the inference results of different classes of the important object by the important object detector 121 (step S901).

For example, in the case of the preprocess parameter management information 231 shown in FIG. 3 and the important object designation information 232 shown in FIG. 4, the important object detector 121 outputs a two-dimensional tensor representing the probability that each region is the important object at resolution with the vertical and horizontal lengths being 1/16 of the original frame. Since the two-dimensional tensor of the probability is calculated for each of “ob1” and “ob2”, in step S901, by setting the maximum value for each element, the probability that the region represented by each element of the two-dimensional tensor is one of one or more important objects is obtained. The arithmetic for aggregating the two-dimensional tensors of the probabilities for a plurality of objects into one two-dimensional tensor is not limited to the calculation of the maximum value, and may be addition or the like.

The arithmetic device 210 calculates the maximum value of the two-dimensional tensor for each compression unit of the encoder 123 and calculates a new two-dimensional tensor (step S902).

For example, in a case of the preprocess parameter management information 231 shown in FIG. 3, the important object designation information 232 shown in FIG. 4, and the encoder 123 being AVC with a macro block size of 16×16, since the two-dimensional tensor calculated in step S901 has resolution corresponding to the number of macro blocks of AVC in the original frame on a one-to-one basis, the two-dimensional tensor is obtained by simply equivalent conversion in step S902. For example, when the downscale coefficient 302 of the preprocess parameter management information 231 is ¼, the arithmetic device 210 applies Max pooling to the two-dimensional tensor calculated at step S901 for each of 4×4 tiles, so that elements of the two-dimensional tensor are converted to correspond to the macro blocks as the compression units on the one-to-one basis. The aggregation process in step S902 is not limited to the calculation of the maximum value, and may be calculation of an average value or the like.

The arithmetic device 210 generates the compression level information of the encoder 123 based on the two-dimensional tensor calculated in step S902 (step S903).

For example, when the encoder 123 is the AVC encoder, the arithmetic device 210 generates a QP value map in which, for each element of the two-dimensional tensor, a predetermined value is assigned as a QP value of a macro block corresponding to an element with a value lower than a predetermined threshold (for example, when each element value of the two-dimensional tensor is in a range of 0 to 1, 0.5 is set as a threshold), and a relatively small predetermined value is assigned as a QP value of a macro block corresponding to an element with a value equal to or higher than the threshold. The threshold and the QP value to be assigned may be designated by the user via the management terminal 201, may be set in the compression level information generation unit 122 in advance, or may be a value adjusted by the arithmetic device 210 so as to achieve target image quality and a target bit rate designated by the user. These values may be different for each data generation source 100 and each object.

The method of converting the two-dimensional tensor calculated in step S902 into the compression level information is not limited thereto. For example, the QP value and the threshold may be controlled for each compression unit so as to improve the rate-distortion performance related to the image quality of the region where the important object exists. Two examples of such control will be described below.

First, a first example will be described. First, a rate distortion curve when the QP value is changed for each macro block is obtained. The rate distortion curve may be obtained by actually assigning a QP value to each macro block and evaluating a rate and distortion, or may be a value predicted using deep learning or the like. Next, according to a first threshold (for example, 0.5), based on the two-dimensional tensor calculated in step S902, each macro block is classified into those included in the important objects and others. Among macro blocks that are not determined as important objects, macro blocks for which the rate-distortion performance is higher than an average and the value of the two-dimensional tensor calculated in step S902 is larger than a second threshold (for example, 0.2) smaller than the first threshold are re-determined as the macro blocks included in the important objects. That is, macro blocks having a good rate distortion characteristic and a small increase in rate due to improvement in image quality are determined as the macro blocks included in the important objects under a looser condition. As a result of this determination, a predetermined QP value is set for the macro blocks determined as those not included in the important objects. The QP value may be a fixed value, or the encoder 123 may assign a different value to each macro block based on setting values such as Constant Rate Factor and Constant Bit Rate. For the macro blocks determined as those included in the important objects, first, the predetermined QP value smaller than the value assigned to the macro block determined to be not an important region is assigned. As a result of assigning the QP, the distortion is reduced to a target value or less by further reducing the QP value with respect to the macro block having the distortion larger than a predetermined distortion target value and the good rate-distortion performance. On the other hand, when the QP is assigned, the rate is improved while preventing the distortion to be equal to or less than the target value by increasing the QP value for the macro block having the distortion smaller than the predetermined distortion target value and the poor rate-distortion performance. According to this control, it is possible to reduce the distortion by a slight increase in rate in the macro block having a good rate distortion, and to reduce the rate by increasing the distortion, which is excessively small in the macro block having a poor rate distortion, within a range of the target or less. As a result, the rate-distortion performance related to the image quality of the important object can be improved in the entire video data.

Next, a second example will be described. In the second example, it is assumed that some frames of video data to be compressed are used as the image 613. First, when the value of each element of the two-dimensional tensor calculated in step S902 is larger than a predetermined threshold, the QP value assigned to the macro block corresponding to the element is assigned to compress the video data. Next, the image quality of the object region indicated by the annotation 614 is evaluated for the compressed video data. Next, a rate of the compressed video data is evaluated. The QP value that provides the best rate-distortion performance is selected based on the image quality of the region of the object and the rate obtained for each QP value in this manner.

Although a specific example of the compression level information generation process is described, the process content is not limited thereto, and any process may be used as long as the compression level information can be generated using the inference results of the important object detector 121 of different classes of important objects.

As described above, according to the first embodiment, since a standard codec is used, compressed data having compatibility can be generated at high speed. By using the detector (model) generated by the Few-shot learning, it is not necessary to prepare and relearn the training data accompanying a change of a definition of the important object. In addition, since the important object detector 121 only detects an important object, learning can be performed at a higher speed than the DNN of the related art. In addition, the process can be executed at high speed by inputting, to the important object detector 121, the processed frame that is subjected to the preprocess such as decreasing the resolution.

### Second Embodiment

In the first embodiment, the combination of the image and the annotation data is used as the important object designation data, but in the second embodiment, natural language such as words or documents is used as the important object designation data. Hereinafter, the second embodiment will be described focusing on differences from the first embodiment.

The system configuration according to the second embodiment is the same as that of the first embodiment. The functional configuration of the compression unit 102 according to the second embodiment is the same as that in the first embodiment. A hardware configuration implementing the compression unit 102 according to the second embodiment is the same as that in the first embodiment. The preprocess parameter management information 231 according to the second embodiment is the same as that of the first embodiment.

In the second embodiment, the user designates an important object by a natural language using the important object designation interface 101 provided to the management terminal 201. For example, when the power transmission steel tower is designated as the important object, the user inputs a character string “power transmission steel tower”. Accordingly, the compression unit 102 compresses the original frame with the power transmission steel tower as the important object.

As a method for designating an important object, one word such as “power transmission steel tower” may be input, or a sentence including two or more words such as “rusting power transmission steel tower” may be input. The natural language input by the user may be English, Japanese, or other languages.

FIG. 10 is a diagram showing an example of a data structure of the important object designation information 232 according to the second embodiment.

The important object designation information 232 is, for example, data in the table format, and stores an entry including a data generation source 1001 and an important object 1002. The field included in the entry is an example, and the entry is not limited to this example.

The data generation source 1001 is a field for storing the identifier of the data generation source 100, and is the same as the data generation source 301. The important object 1002 is a field for storing a natural language designating an important object.

The important object designation information 232 shown in FIG. 10 includes entries 1011 and 1012 registered by the user.

In the entry of the important object designation information 232 according to the second embodiment, the field of the object class is omitted. This is based on an assumption that two or more pieces of important object designation data are unnecessary for one class of object in the second embodiment in which an object is designated in a natural language, unlike the first embodiment in which important object designation data includes a combination of one or more images and annotation data. The invention is not limited thereto, and as in the first embodiment, two or more pieces of important object designation data including different natural languages may be registered for one class of object.

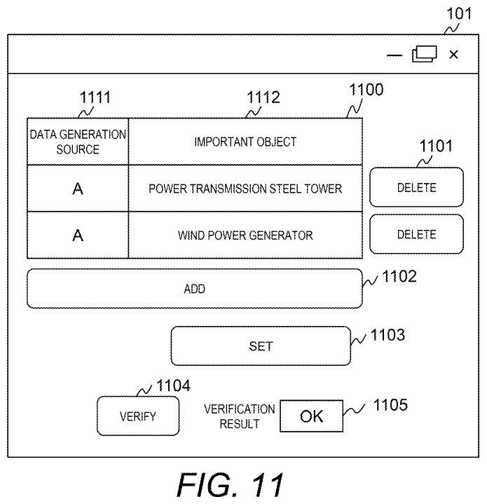

The registration process of the important object designation data according to the second embodiment is the same as that of the first embodiment, but the important object designation interface 101 is different. FIG. 11 is a diagram showing an example of the important object designation interface 101 provided by the compression unit 102 according to the second embodiment.

As in the first embodiment, the important object designation interface 101 according to the second embodiment displays a table 1100 for checking and registering the important object designation data. The table 1100 stores an entry (important object designation data) including ae data generation source 1111 and an important object 1112.

The data generation source 1111 is the same field as the data generation source 611. The important object 1112 is a field for storing a natural language for designating an important object.

A delete button 1101, an add button 1102, a setting button 1103, and a verification button 1104 are the same operation buttons as the delete button 601, the add button 602, the setting button 603, and the verification button 604.

The flow of the compression process of the second embodiment is the same as that of the first embodiment, but some process contents are different. In step S705, the arithmetic device 210 performs inference using the natural language included in the important object designation data as an input to the important object detector 121.

As the important object detector 121 in this case, for example, a neural network model of a Semantic Segmentation task capable of designating a target object by text can be used. Among such neural network models, for example, there is a model in which a plurality of words separated by commas are input, and thus it is possible to execute Semantic Segmentation of a plurality of classes of objects in one inference. In such a case, in steps S703 to S706, instead of performing the loop for each object, a character string may be generated by connecting objects associated with the data generation source of the original frame with, for example, comma for separation, and the character string and the processed frame may be used as the input of the important object detector 121. In addition, step S705 is not limited thereto, and for example, the important object may be designated by generating an image described in a natural language and annotation data thereof using a deep learning model of Text-to-Image Translation, and inputting the generated image and annotation data thereof as a support set to the deep learning model of Semantic Segmentation using Few-shot learning as described in the first embodiment. In addition, an important object may be designated by performing inference using the neural network model of the Semantic Segmentation task capable of designating a target object by text with a part of frames of video to be compressed as an input, and inputting a support set in which the result is annotation data and the frame is an image to the deep learning model of Semantic Segmentation using the Few-shot learning as described in the first embodiment.

The first embodiment and the second embodiment may be combined. That is, the user may register a combination of an image and annotation data or important object designation data including a natural language via the important object designation interface 101. In this case, in step S705, the deep learning model is selectively used according to the class of the important object designation data stored in the important object designation information 232. In addition, a combination of an image and annotation data, a natural language, or data obtained by converting both may be managed as the important object designation information 232. For example, such conversion data is tensor data obtained by previously executing processing on the support set in the Semantic segmentation model using the Few-shot learning. Hereinafter, information describing an object such as a combination of an image and annotation data, a natural language, and such conversion data is referred to as important object description information.

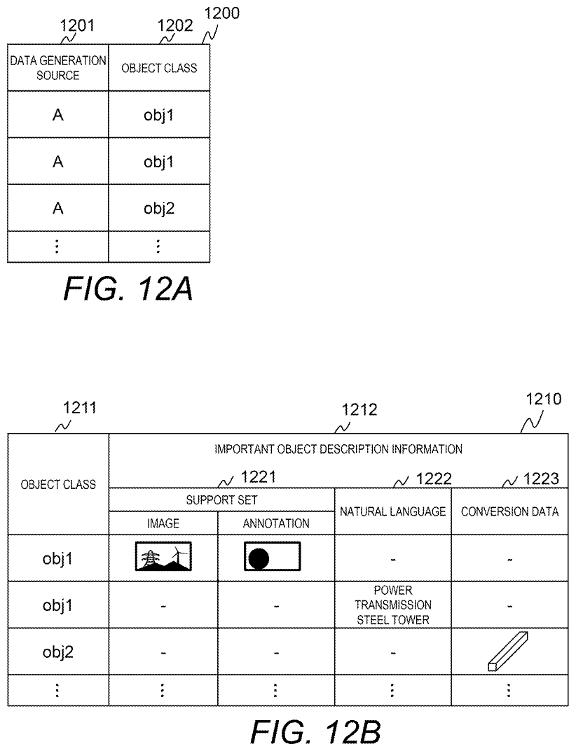

An example of the important object designation information 232 in this case is shown in FIGS. 12A and 12B. The important object designation information 232 is divided into first information 1200 (FIG. 12A) for managing an association between the data generation source and the object class, and second information 1210 (FIG. 12B) for managing an association between the object class and the important object description information.

The first information 1200 stores an entry including a data generation source 1201 and an object class 1202. The second information 1210 stores an entry including an object class 1211 and important object description information 1212. The important object description information 1212 includes a support set 1221, a natural language 1222, and conversion data 1223. By managing in this manner, definition information of an important object can be shared by a plurality of data generation sources 100.

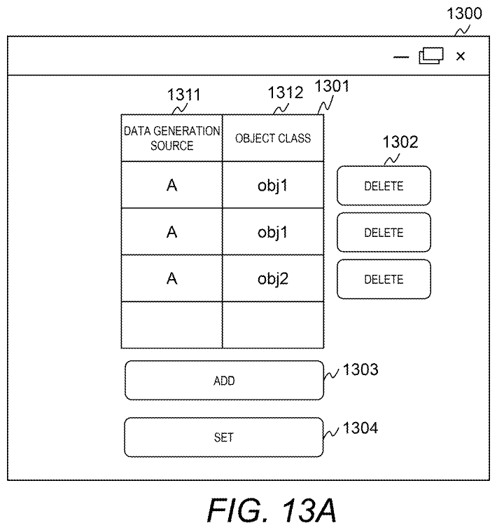

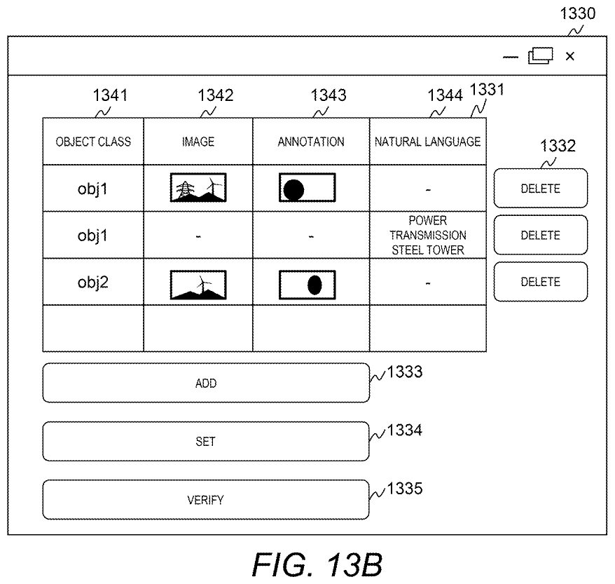

FIGS. 13A and 13B are diagrams showing an example of the important object designation interface 101 for designating the important object designation information 232 shown in FIGS. 12A and 12B.

A first interface 1300 shown in FIG. 13A is an interface for setting the first information 1200, and a second interface 1330 shown in FIG. 13B is an interface for setting the second information 1210.

The first interface 1300 includes a table 1301 for inputting a data generation source 1311 and an object class 1312. A delete button 1302, an add button 1303, and a setting button 1304 are the same operation buttons as the delete button 601, the add button 602, and the setting button 603. The first interface 1300 may be included in an interface through which the compression unit 102 receives data from the data generation source 100. That is, a compression request of the data from the data generation source 100 to the compression unit 102 may include information on the object class corresponding to the generated data.

The second interface 1330 includes a table 1331 for inputting an object class 1341, an image 1342, an annotation 1343, and a natural language 1344. The delete button 1332, the add button 1333, the setting button 1334, and the verification button 1335 are the same operation buttons as the delete button 601, the add button 602, the setting button 603, and the verification button 604.

Note that the invention can be used to compress various kinds of multi-dimensional data such as sensor data including sensor values and times, in addition to images such as still images and videos.

The invention is not limited to the above-described embodiments, and includes various modifications. For example, the above-described embodiments are described in detail in order to describe the invention in an easy-to-understand manner, and the invention is not necessarily limited to those including all the described configurations. A part of a configuration in each embodiment may be added to, deleted from, or replaced with another configuration.

A part or all of configurations, functions, processing units, processing methods, and the like described above may be implemented by hardware by, for example, designing with an integrated circuit. The invention can also be implemented by a program code of software for implementing the functions in the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid-state drive (SSD), an optical disk, a magneto-optical disk, a CD-R, a magnetic tape, a nonvolatile memory card, and a ROM.

Further, the program code for implementing the functions described in the present embodiments can be implemented in a wide range of programs or script languages such as assembler, C/C++, Perl, Shell, PHP, Python, and Java (registered trademark).

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the configurations may be connected to one another.

What is claimed is:

1. A computer system comprising:
at least one computer including a processor, a storage device connected to the processor, and an interface connected to the processor;
a model configured to output inference data indicating importance of each region of multi-dimensional data;
a compression level information generation unit configured to generate compression level information including a parameter for determining a data amount for each region of the multi-dimensional data based on the inference data; and
a compressor configured to generate the compressed data in a data format having ensured compatibility with a transmission destination of compressed data by lossy compression using the compression level information.

2. The computer system according to claim 1, wherein
the compression level information generation unit generates the compression level information for generating the compressed data in which a data amount of an important region is large and a data amount of an unimportant region is small based on the inference data.

3. The computer system according to claim 2, further comprising:
a preprocessing unit configured to execute a preprocess of processing the multi-dimensional data so as to reduce a calculation cost of the model, wherein
the multi-dimensional data processed by the preprocessing unit is input to the model.

4. The computer system according to claim 3, wherein
the computer system holds preprocess parameter management information for managing data in which an acquisition source from which the multi-dimensional data is acquired and a preprocess parameter for controlling the preprocess are associated with each other, and
the preprocessing unit acquires the preprocess parameter by referring to the preprocess parameter management information based on the acquisition source of the multi-dimensional data, and executes the preprocess using the acquired preprocess parameter.

5. The computer system according to claim 4, wherein
the multi-dimensional data is a moving image, and
the preprocess is a process of reducing resolution of the multi-dimensional data.

6. The computer system according to claim 2, wherein
the model is a model generated by Few-shot learning using, as an input, important object description information including at least one of a combination of an image and annotation data for designating an important object to be detected, a natural language for designating an important object to be detected, and data obtained by converting at least one of the combination and the natural language, and
a probability that the important object is included is output for each region of the multi-dimensional data.

7. The computer system according to claim 6, wherein
the computer system holds important object designation information for managing important object designation data in which an acquisition source from which the multi-dimensional data is acquired, a class of an important object of interest, and the important object description information are associated, and
the important object description information included in the important object designation data corresponding to the acquisition source of the multi-dimensional data is input to the model.

8. The computer system according to claim 6, wherein
the computer system holds first information for managing an association between an acquisition source from which the multi-dimensional data is acquired and a class of an important object of interest, and second information for managing an association between a class of an important object and the important object description information,
a class of the important object corresponding to the acquisition source of the multi-dimensional data is acquired from the first information,
the important object description information corresponding to the acquired class of the important object is acquired from the second information, and
the acquired important object description information is input to the model.

9. The computer system according to claim 8, further comprising:
an interface for setting the first information; and
an interface for setting the second information.

10. The computer system according to claim 9, further comprising:
an interface for instructing verification of the important object description information; and
an interface for acquiring the important object description information.

11. The computer system according to claim 5, wherein
the compression level information includes a parameter representing a compression degree for each compression unit of the compressor.

12. A data compression method executed by a computer system,
the computer system including
at least one computer including a processor, a storage device connected to the processor, and an interface connected to the processor, and
a model configured to output inference data indicating importance of each region of multi-dimensional data,
the data compression method comprising:
the computer system acquiring the inference data by inputting the multi-dimensional data to the model;
the computer system generating compression level information including a parameter for determining a data amount of each region of the multi-dimensional data based on the inference data; and
the computer system generating the compressed data in a data format having ensured compatibility with a transmission destination of the compressed data by lossy compression using the compression level information.
